(19) United States
(12) Patent Application Publication
(10) Pub. No.: US 2024/0144198 A1
(43) Pub. Date: May 2, 2024

(54) Machine Learning-based Knowledge Management for Incident Response

(71) Applicant: Bank of America Corporation, Charlotte, NC (US)

(72) Inventors: Gilbert M. Gatchalian, Union, NJ (US); Brian Christman, Dublin, TX (US); Kamal D. Sharma, Mason, OH (US); Karthik Rajagopalan, Glen Allen, VA (US); Kevin A. Delson, Woodland Hills, CA (US); Ronnie Rosseland, Huntersville, NC (US); Yassine Touahri, Charlotte, NC (US); Amer Ali, Jersey City, NJ (US)

(21) Appl. No.: 17/978,592

(22) Filed: Nov. 1, 2022

(51) Int. Cl. G06Q 10/10; G06F 16/35; G06F 40/279

(52) U.S. Cl. CPC G06Q 10/1097; G06F 16/35; G06F 40/279

(57) ABSTRACT

Systems, devices, and methods for machine learning based processing of service requests is described. A user device may send a service request to a service management platform. Based on keywords in the request and a knowledge base, the service management platform may send indications of one or more prospective solutions to the user device. The service management platform may update the knowledge base based on success or failure of the prospective solution.

### FIELD

Aspects described herein generally relate to the field of artificial intelligence (AI) and machine learning (ML), and more specifically to using AI/ML algorithms for collating, modifying, and providing technical support information for incident resolution.

### BACKGROUND

Computing networks, devices, and applications at both enterprise and consumer level, may be associated with complex, interconnected systems and sub-systems. An end-user of a device or an application may often encounter a technical issue (e.g., resulting from a malfunction of a specific component or sub-system) or may simply need expert assistance on how to perform a specific task that the device or application may be capable of. Vendors often include extensive documentation that may include information on how frequently encountered issues may be resolved or how a particular task may be performed. Additionally, enterprises and/or vendors may have specific groups/departments tasked with responding to technical issues and/or other incidents as may encountered within enterprise networks and/or devices. However, many issues and support requests may still require significant expert research, consultations, and trial-and-error methodologies for resolution.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with collating and providing technical support information for resolving incidents. For example, the methods, devices, and systems described herein enable automated and efficient gathering, ranking, and disseminating of support information.

In accordance with one or more arrangements, a service management platform may comprise at least one processor; and memory storing computer-readable instructions that, when executed by the at least one processor, cause the service management platform to perform one or more operations. In accordance with one or more arrangements, the service management platform may receive, from a first user computing device, a first service request. The first service request may comprise a first service description. The service management platform may assign, to the first service request, a ticket number. The service management platform may receive, from a second user computing device, an indication for closing of the first service request, and further identify, based on the ticket number, one or more communications associated with the first service request. Based on natural language processing (NLP) of the one or more communications and the first service description, the service management platform may extract one or more first keywords associated with the one or more communications and the first service description. The service management platform may tag, with the one or more first keywords, a subset of the one or more communications and the first service description and perform cluster analysis, based on the first one or more keywords. The service management platform may perform the cluster analysis to add the subset of the one or more communications and the first service description to one or more groups of solutions in a knowledge base. The service management platform may receive, from a third user computing device, a second service request. The second service request may comprise a second service description. Based on NLP of the second service description, the service management platform may extract one or more second keywords associated with the second service description. Based on determining a match between the one or more first keywords and the one or more second keywords, the service management platform may send, to the third user computing device, at least one solution of the one or more groups of solutions.

In some arrangements, the service management platform may tag the subset of the one or more communications and the first service description based on identifying, within the one or more communications, one or more trigger words. In some arrangements, the service management platform may tag the subset of the one or more communications and the first service description based on receiving an indication that the first service request has been resolved.

In some arrangements, the subset of the one or more communications may comprise one or more prospective solutions for the first service request. In some arrangements, the one or more communications comprise one or more: emails, text messages, instant messages, voice transcripts, screen captures, or documents.

In some arrangements, the one or more first keywords may comprise an identifier of a computing resource associated with the first service request. The computing resource may be one of a computing device, software application, or a computing system.

In some arrangements, the service management platform may send the at least one solution of the one or more groups of solutions based on ranking prospective solutions in the one or more groups of solutions based on a historical record of success of the prospective solutions. The at least one solution may be a highest ranked solution in the one or more groups of solutions.

In some arrangements, the subset of the one or more communications may comprise keywords indicating success of prospective solutions in the subset for resolving the service request.

In some arrangements, the clustering analysis comprises one or more of hierarchical clustering, centroid based clustering, density based clustering, or distribution based clustering.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for a machine-learning based information technology service management (ITSM), in accordance with one or more arrangements;

FIG. 1B shows an example service management platform, in accordance with one or more example arrangements;

FIGS. 2A and 2B show an example event sequence for generating a knowledge base and processing a service request, in accordance with one or more example arrangements;

FIG. 3 shows an example method for processing a service request, in accordance with one or more example arrangements;

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Enterprise organizations may have dedicated information technology service management (ITSM) systems for maintaining and troubleshooting issues within computing and networking resources associated with internal operations of the enterprise and/or external services provided by the enterprise. ITSM may have employees who are subject matter experts (SMEs) with respect to the various computing resources (e.g., computing systems, devices, and applications) utilized/provided by the organizations. The computing resources may be associated internal operations within the organization (e.g., email applications, database management systems, payroll systems, timekeeping systems, project lifecycle systems, etc.) or may be associated with devices/services as provided by the enterprise organization to its external clients/consumers. In addition, ITSM may be associated with internal knowledge bases for troubleshooting technical issues/incidents that may occur within the computing resources operated, maintained, and/or service by the organization. For example, a service management team (e.g., associated with an ITSM system) may be tasked to create documentation in a knowledge base with a listing frequently encountered issues within the computing resources and possible solutions to those issues.

Manually creating a knowledge base to refer and respond to incidents may be a tedious, error prone and time consuming process. Service management teams may not have bandwidth required to create and maintain knowledge bases proactively. For example, a service management team may resolve a previously unknown issue but may not be able to edit the internal knowledge base with the issue and the solution corresponding to the issue. The knowledge may either exist with subject matter experts, and within collaboration and communication tools (e.g., internal message boards, chats/instant messages, emails, etc.) used for internal consultation/research by the team. Once the incident is resolved, there may not be an adequate follow-up to curate this knowledge, into the knowledge base, for reuse by other teams/members. As such, this knowledge of previous incident resolution may not be efficiently used to resolve similar issues as and when they recur in future. This may result in inefficient usage of time and resources of the organization. It may also lead to delays to urgent/critical high priority incidents if responding support personnel were not involved in resolving the previous occurrence of the incident.

Various examples herein describe a machine learning-based ITSM system to systematically curate various sources and forms of communication (as used by support personnel to resolve an issue/service request) into a knowledge base for providing solutions for any future similar issues/service requests. For example, the machine learning system may scan various databases, systems, and resources as may be used by the support personnel (e.g., based on a ticket number as issued for an incident report) and organize the information into the knowledge base (e.g., natural language processing (NLP) algorithms and clustering algorithms). The knowledge base may be used to provide and/or execute solutions in response to future incident reports. The system may also modify/update the knowledge base based on successful usage of prospective solutions, as provided by the knowledge base, for future incidents. The system may also rank the prospective solutions (e.g., based on a likelihood of incident resolution, a source of a prospective solution, etc.) when providing the solutions for future incident reports.

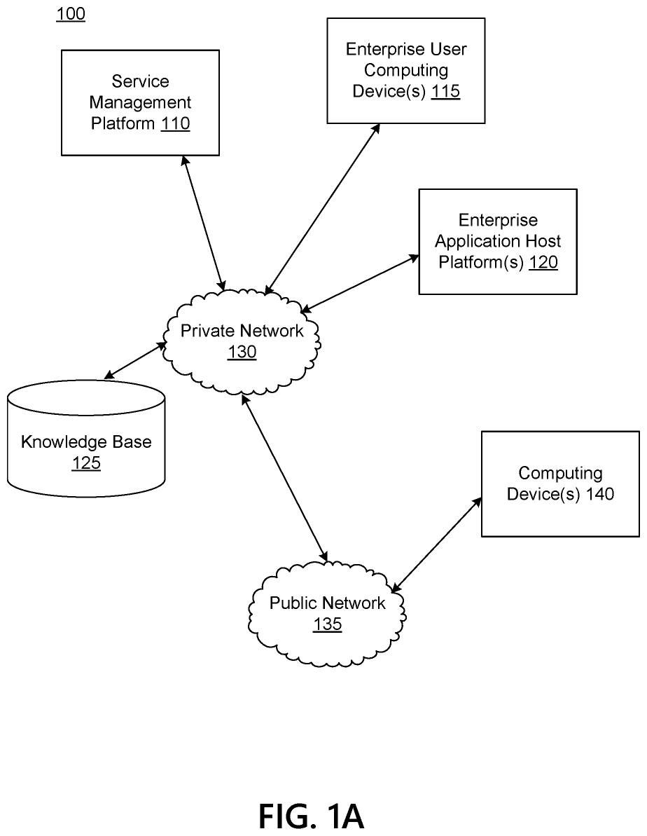

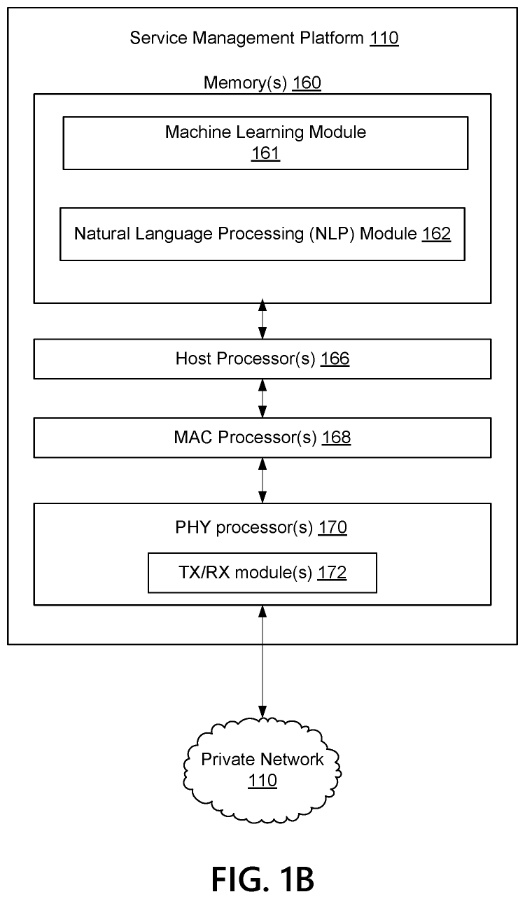

FIG. 1A shows an illustrative computing environment 100 for a machine-learning based ITSM, in accordance with one or more arrangements. The computing environment 100 may comprise one or more devices (e.g., computer systems, communication devices, and the like). The one or more devices may be connected via one or more networks (e.g., a private network 130 and/or a public network 135). For example, the private network 130 may be associated with an enterprise organization which may develop and support service, applications, and/or systems for its end-users. The computing environment 100 may comprise, for example, a service management platform 110, an knowledge base 125, one or more enterprise user computing device(s) 115, and/or one or more enterprise application host platform(s) 120 connected via the private network 130. Additionally, the computing environment 100 may comprise one or more computing device(s) 140 connected, via the public network 135, to the private network 130. Devices in the private network 130 and/or authorized devices in the public network 135 may access services, applications, and/or systems provided by the enterprise application host platform 120 and supported/serviced/maintained by the service management platform 110.

The devices in the computing environment 100 may transmit/exchange/share information via hardware and/or software interfaces using one or more communication protocols over the private network 130 and/or the public network 135. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), and the like).

The service management platform 110 may comprise one or more computing devices and/or other computer components (e.g., processors, memories, communication interfaces) configured to perform one or more functions as described herein. Further details associated with the architecture of the service management platform 110 are described with reference to FIG. 1B.

The enterprise application host platform 120 may comprise one or more computing devices and/or other computer components (e.g., processors, memories, communication interfaces). In addition, the enterprise application host platform 120 may be configured to host, execute, and/or otherwise provide one or more services/applications for the end users. The end users may be employees associated with the enterprise organization, or may be consumers of a product/service provided by the enterprise organization. For example, the enterprise application host platform 120 may be configured to host, execute, and/or otherwise provide one or more email applications, video conferencing applications, text-based chat applications, voice call systems, tools for IT incident reporting, ticket management, and incident resolution, etc. As another example, if the computing environment 100 is associated with a financial institution, the enterprise application host platform 120 may be configured to host, execute, and/or otherwise provide one or more transaction processing programs (e.g., online banking applications, fund transfer applications, electronic trading applications), applications for generation of regulatory reports, and/or other programs associated with the financial institution. As another example, if the computing environment 100 is associated with an online streaming service, the enterprise application host platform 120 may be configured to host, execute, and/or otherwise provide one or more programs for storing and providing streaming content to end-user devices. The above are merely exemplary use-cases for the computing environment 100, and one of skill in the art may easily envision other scenarios where the computing environment 100 may be utilized to provide and support end-user applications.

The enterprise user computing device(s) 115 may be personal computing devices (e.g., desktop computers, laptop computers) or mobile computing devices (e.g., smartphones, tablets). In addition, the enterprise user computing device(s) 115 may be linked to and/or operated by specific enterprise users (who may, for example, be employees or other affiliates of the enterprise organization). An authorized user (e.g., an employee) may use an enterprise user computing device 115 to develop, test and/or support services/applications provided by the enterprise organization. The enterprise user computing device(s) 115 may download neural network models from the knowledge base 125 for local usage and/or usage within the private network 130. Further, the enterprise user computing device(s) 115 may have and/or access tools/applications to operate and/or train neural network models for various services/applications provided by the enterprise organization.

The computing device(s) 140 may be personal computing devices (e.g., desktop computers, laptop computers) or mobile computing devices (e.g., smartphones, tablets). An authorized user (e.g., an end-user) may use a computing device 140 to access services/applications provided by the enterprise organization, or to submit service requests and/or incident reports associated with any of the services/applications.

The knowledge base 125 may comprise may comprise information corresponding to issues that may occur within computing resources associated with the enterprise organization. For example, the knowledge base 125 may comprise prospective solutions to one or more possible issues that may occur within the computing resources. The prospective solutions may be solutions as submitted by various SMEs/members of a service management team in response to prior incidents recorded by the ITSM system, as may have been submitted/uploaded by various users connected to the private network 130 and/or the public network 135. The service management platform 110, in accordance with various procedures described herein, categorize/tag solutions to historical incidents and store the solutions in the knowledge base 125. The service management platform 110, in response to an incident (e.g., as reported by a user within the computing environment 100), may scan the knowledge base 125 to provide/execute one or more possible solutions for the incident. The knowledge base may be associated with one or more of volatile and nonvolatile, removable and non-removable media implemented in any method or technology for storage of information such as computer readable instructions, data structures, program modules and/or other data. Computer-readable storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium.

In one or more arrangements, the service management platform 110, the knowledge base 125, the enterprise user computing device(s) 115, the enterprise application host platform(s) 120, the computing device(s) 140, and/or the other devices/systems in the computing environment 100 may be any type of computing device capable of receiving input via a user interface, and communicating the received input to one or more other computing devices in the computing environment 100. For example, the service management platform 110, the knowledge base 125, the enterprise user computing device(s) 115, the enterprise application host platform(s) 120, the computing device(s) 140, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the service management platform 110, the knowledge base 125, the enterprise user computing device(s) 115, the enterprise application host platform(s) 120, the computing device(s) 140, and/or the other devices/systems in the computing environment 100 may, in some instances, be and/or comprise special-purpose computing devices configured to perform specific functions.

FIG. 1B shows an example service management platform 110, in accordance with one or more examples described herein. The service management platform 110 may comprise one or more of host processor(s) 166, medium access control (MAC) processor(s) 168, physical layer (PHY) processor(s) 170, transmit/receive (TX/RX) module(s) 172, memory 160, and/or the like. One or more data buses may interconnect host processor(s) 166, MAC processor(s) 168, PHY processor(s) 170, and/or Tx/Rx module(s) 172, and/or memory 160. The service management platform 110 may be implemented using one or more integrated circuits (ICs), software, or a combination thereof, configured to operate as discussed below. The host processor(s) 166, the MAC processor(s) 168, and the PHY processor(s) 170 may be implemented, at least partially, on a single IC or multiple ICs. Memory 160 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 168 and/or the PHY processor(s) 170 of the service management platform 110 may be configured to generate data units, and process received data units, that conform to any suitable wired and/or wireless communication protocol. For example, the MAC processor(s) 168 may be configured to implement MAC layer functions, and the PHY processor(s) 170 may be configured to implement PHY layer functions corresponding to the communication protocol. The MAC processor(s) 168 may, for example, generate MAC data units (e.g., MAC protocol data units (MPDUs)), and forward the MAC data units to the PHY processor(s) 170. The PHY processor(s) 170 may, for example, generate PHY data units (e.g., PHY protocol data units (PPDUs)) based on the MAC data units. The generated PHY data units may be transmitted via the TX/RX module(s) 172 over the private network 130. Similarly, the PHY processor(s) 170 may receive PHY data units from the TX/RX module(s) 172, extract MAC data units encapsulated within the PHY data units, and forward the extracted MAC data units to the MAC processor(s). The MAC processor(s) 168 may then process the MAC data units as forwarded by the PHY processor(s) 170.

One or more processors (e.g., the host processor(s) 166, the MAC processor(s) 168, the PHY processor(s) 170, and/or the like) of the service management platform 110 may be configured to execute machine readable instructions stored in memory 160. The memory 160 may comprise one or more program modules/engines having instructions that when executed by the one or more processors cause the service management platform 110 to perform one or more functions described herein. The one or more program modules/engines and/or databases may be stored by and/or maintained in different memory units of the service management platform 110 and/or by different computing devices that may form and/or otherwise make up the service management platform 110. For example, the memory 160 may have, store, and/or comprise a machine learning module 161 and a natural language processing (NLP) module 162.

The service management platform 110 may access communications between the various devices/systems within the computing environment 100. For example, the service management platform 110 may be configured to receive, process, and store data/communications via one or more email applications, video conferencing applications, text-based chat applications, voice call systems, and/or tools for IT incident reporting, ticket management, and incident resolution, etc.

The machine learning module 161 may have instructions/algorithms that may cause the service management platform 110 to implement machine learning processes in accordance with the examples described herein. The machine learning module 161 may receive data (e.g., from the communications with the computing platform 100) and, using one or more machine learning algorithms, may generate one or more machine learning datasets. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

In one example where the machine learning module 161 implements a clustering algorithm, the machine learning module 161 may comprise instructions/algorithms that may cause the service management platform 110 to perform clustering operations on keywords extracted (e.g., from one or more communications within the computing environment 100) by the NLP module 162 (e.g., as further described herein). For example, the clustering operations may comprise performing non-supervised machine learning operations on the keywords to categorize the keywords, and/or the one or more communications associated with the keywords, into a plurality of groups.

While FIG. 1A illustrates the service management platform 110, the enterprise user computing device(s) 115, the enterprise application host platform 120, and the knowledge base 125 as being separate elements connected in the private network 130, in one or more other arrangements, functions of one or more of the above may be integrated in a single device/network of devices. For example, elements in the service management platform 110 (e.g., host processor(s) 166, memory(s) 160, MAC processor(s) 168, PHY processor(s) 170, TX/RX module(s) 172, and/or one or more program/modules stored in memory(s) 160) may share hardware and software elements with and corresponding to, for example, the enterprise application host platform 120 and/or the enterprise user device(s) 115.

Employees, clients, and/or users associated with an enterprise organization may a submit service request for an issue associated with a computing resource (e.g., computing system, device, and/or applications). For example, the service request may be for reporting an error/malfunction, requesting expert assistance for operating/using a particular resource, or simply a query regarding the resource. A service management system (e.g., comprising one or more computing devices/servers, software tools, etc.) may assign a reference number (e.g., a ticket number) to the service request. An SME may review the ticket and provide a solution to corresponding to the service ticket. In some example, a triage call may be initiated (e.g., via a telephone/video conference, an instant messaging service) between one or more SMEs, a user who may have submitted the service request, and/or one or more vendor representatives associated with the computing resource. to discuss possible solutions (e.g., between team members, vendors) for the service request. During the triage call, multiple prospective solutions may be discussed and executed in an attempt to overcome the issue. Executing a prospective solution may comprise an SME requesting the user to perform a series of steps via the computing resource, assuming control of the computing resource by the SME to perform a series of steps, sending one or more programming commands (e.g., via a messaging window, an email, etc.) for the user to execute via the computing resource, and/or the like.

Therefore, multiple channels may be used for coordination, communication, and/or resolution of an incident. However, information and technical expertise so obtained during such a resolution (e.g., via a triage call, via other forms of communication) may not necessarily be recorded in a knowledge bases for future reference and use for resolving similar issues. The useful information for resolving the issue may be present in multiple systems (video conference archives, email inboxes, voice chat transcripts, instant messaging applications, etc.). Such information is not easily retrievable and/or available for future use. While support teams/SMEs may create internal documentation for future reference, the documentation may not be adequately updated based on latest discussions and solutions as provided for incident tickets.

Further, “cross-pollination” may occur whereby solutions application for one technology may be used for one or more other technology. For example, two applications may have similar issues because underlying code associated with the two applications may be same. While, SMEs may manually create documentation for troubleshooting a specific application, the documentation would not be readily referred by an SME while trying to resolve a service ticket involving another application. Documentation may also not be effective means for issue resolution across a large enterprise. For example, one line of business of a large organization may not be aware of a solution as devised by another department/line of business of the organization for a similar issue.

Various examples herein describe a system for gathering, curating, and proactively modifying a knowledge base for proving solutions to service requests as submitted by users associated with the enterprise organization. Various examples herein describe a service management platform that uses one or more machine learning tools to collate information, into a knowledge base, from multiple sources (e.g., using a ticket number associated with a service request). The information may comprise prospective solutions, for a service request, as proposed by SMEs, obtained from technical documentation, sent via emails, instant messaging applications, discussed during a conference call, etc. Further, NLP-based algorithms may be used to extract keywords from the information. A clustering algorithm may be used to categorize the keywords and prospective solutions associated with the keywords into one or more groups. In response to receiving a new service request with same/similar keywords, the service management platform may send one or more of the prospective solutions as previously categorized for the keywords. A user, submitting the new service request may prompted to attempt one or more of the prospective solutions as sent by the service management platform.

Further, the system may flexibly modify the knowledge base based on whether a prospective solution has worked for the issue. The user may be prompted to notify the service management platform whether a prospective solution has worked. If the prospective solution has worked, the service management platform may increase a likelihood that the solution would be proposed for a similar, future issue. If the prospective solution does not work, the service management platform may reduce a likelihood that the solution would be proposed for a similar, future issue. This would reduce any inefficiencies that may arise from users attempting solutions that are less likely to succeed.

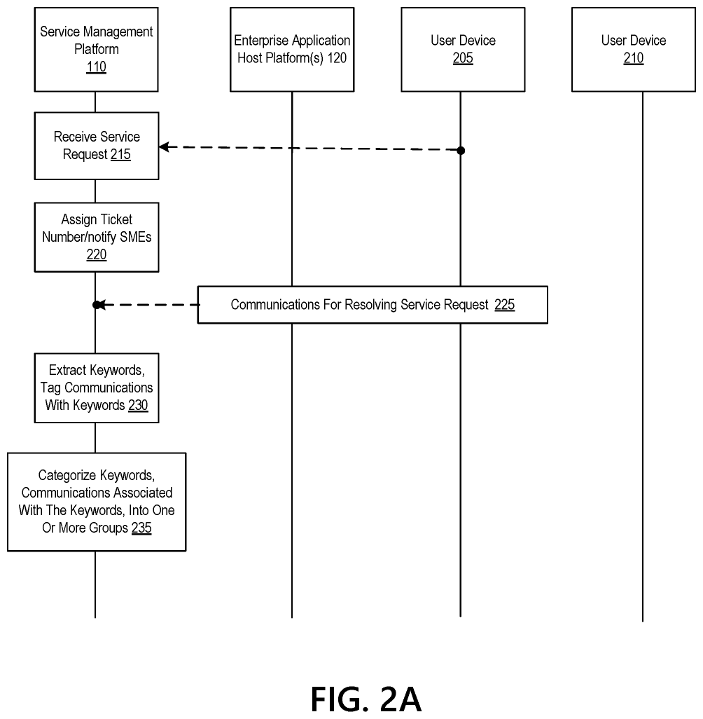

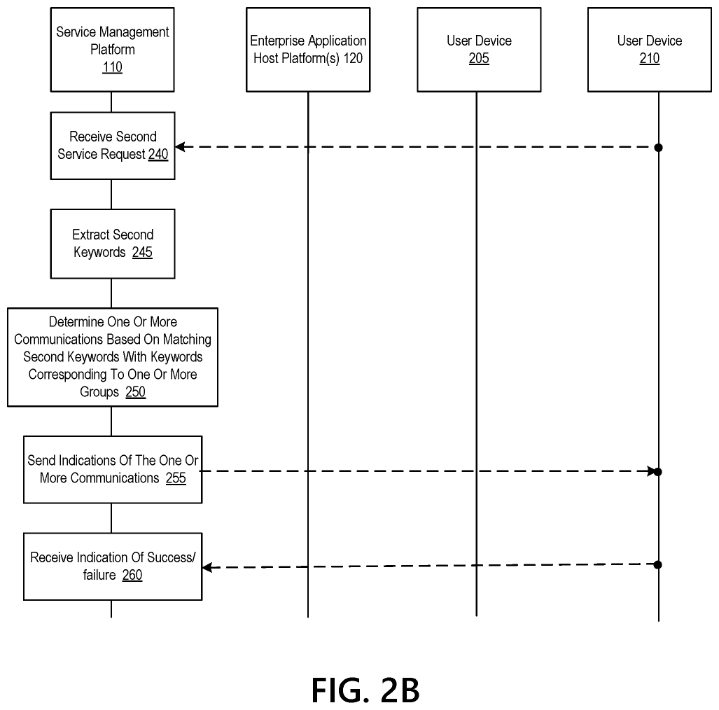

FIGS. 2A and 2B show an example event sequence for generating a knowledge base and processing a service request. The example event sequence may be performed at one or more devices as shown in the computing environment 100.

At step 215, the service management platform 110 may receive a service request as input by a user at a user device 205. The user device 205 may be, for example, the enterprise user computer device 115 or the computing device 140. The service request may be for reporting an error/malfunction (e.g., incident) involving a computing resource, requesting expert assistance for operating/using a computing resource, or simply a query regarding a computing resource. The computing resource may be a computing system, device, application, and/or the like. The computing resource may be, for example, the user device 205.

The service request may comprise an indication of the computing resource (e.g., application name/version number, computing device name/model number). The service request may additionally comprise a description of the service request. The description may comprise symptoms being exhibited by the computing resource, operations being attempted on the computing resource, error codes being displayed for the computing resources, etc.

At step 220, the service management platform 110 may assign a ticket number to the service request. The service management platform 110 may further send alerts/notifications to one or more SMEs associated with a support team of the enterprise organization. The support team may comprise personnel tasked with maintenance of computing resources and/or troubleshooting issues as and when they occur within the computing environment. For example, the service management platform 110 may send a notification via an instant messaging service and/or an email to one or more members of the support team. The notification may comprise the ticket number, indication of the computing resource, and/or a description of the service request.

At step 225, one or more members of the support team may open one or more channels of communication for resolving the service request. The one or more channels of communication may be with a user who may have submitted the service request and/or the computing resource for which the service request was submitted. The one or more channels of communication may be with the user and/or one or more other SMEs (within or outside the support team). The one or more channels of communication may be a voice/video call/conference tools, text chat/instant messaging applications, email messaging applications, screen sharing/remote device controlling applications, etc.

The one or more channels of communications may be used to send/receive and/or attempt one or more prospective solutions for resolving the service request. For example, if the service request is associated with a computing server servicing one or more applications within the computing environment 100, a support team member may log onto the server (e.g., as an administrator) to review possible sources of the error/malfunction. As another example, if the service request is for an application/tool operating on the user device 205, a support team member may access/view contents of the display screen of the user device 205 or the computing resource associated with the service request. As another example, a support team member may open/download and/or send (e.g., to the user device 205) a technical service/support manual (or a link to the manual) for resolving the service request. As another example, a support team member may send a notification message (e.g., an email or instant message) to one or more other employees who may have expertise in operating the computing resource associated with the service request.

Any communications associated with resolving the service request, via the one or more channels of communications, may be gathered/received by the service management platform 110. For example, the service management platform 110 may store voice transcripts, text exchanges, program lines (e.g., code/code fragments), screen shots/screen captures, videos, documents, links, indications of SMEs involved/notified, and/or any other information exchanged for resolution of the service ticket.

In an arrangement, the communications may be identified/gathered based on the assigned ticket number for the service request. For example, emails associated with the service request may comprise the ticket number and may be identified based on the ticket number. As another example, a communication channel for the service request may be identified based on determining that the channel was opened, by a support team member, to a phone number/computing device associated with the user of the user device 205 (e.g., via which the service request was initiated). Any or all communications performed via the communication channel may be identified as corresponding to the service request. The service management platform 110 may also identify any other SMEs/experts, associated with the computing resource, who may have been notified regarding the service request.

At step 230, the service management platform 110 may extract keywords from the service request description and the identified communications (e.g., as identified at step 225). For example, the NLP module 162 may use a keyword extraction algorithm for identifying one or more keywords. The keyword extraction algorithm may remove words that may occur with high frequency and may not convey any useful information (e.g., a, an, the, in, on, etc.) and further remove any forms of punctuation and/or special characters that may be used. The keyword extraction algorithm may further extract the most-commonly used keywords and/or n-grams within the service request description and the identified communications. The keyword extraction algorithm may further extract information regarding any other SMEs/experts, associated with the computing resource, who may have been notified regarding the service request. The keyword extraction algorithm may enable determination of words and/or phrases that may correspond to symptoms associated with the service request, computing resources associated with the service request, error code associated with the service request, prospective solutions attempted for resolving the service request, whether the attempted prospective solution was successful or not for resolving the service request, etc.

The service management platform 110 may further perform audio-to-text transcription of any audio/video calls within the identified communications. Keyword extraction may follow the audio-to-text transcription process, and may operate on the text determined using the audio-to-text transcription process.

Keyword extraction may follow closing of a ticket associated with the service request. For example, a support team member may close the ticket (e.g., following resolution of the service request). An enterprise user computing device 115 may send an indication of the closing of the ticket to the service management platform 110. Based on receiving the indication, the service management platform 110 may perform the keyword extraction. As another example, keyword extraction may be based on/follow detecting trigger phrases, within the communications, indicating that the service request has been resolved. For example, the trigger phrases may be “it works,” “no error,” “error has cleared,” and/or the like. the NLP module 162 may determine/analyze noun phrases and/or n-grams within the communications to determine presence of trigger phrases.

Following detection of trigger phrases, the service management platform 110 may tag at least a subset of the communications and/or the service description (corresponding to the determined keywords) with the extracted keywords. For example, if keyword 1 was detected within a statement as spoken by an SME/support team member, the statement itself may be tagged with the keyword. As another example, if an email within the communications included a keyword 2, the email may be tagged with the keyword. As another example, if an uploaded document within the communications included a keyword 3, the document may be tagged with the keyword 3.

Tagging a communication with a keyword may comprise tagging an indication of whether an attempted prospective solution (for resolving the service request), as included within the communication, was successful or not. The NLP module 162 may determine whether the attempted prospective solution was successful based on a contextual analysis algorithm or based on presence of trigger words (e.g., “working,” “not working,” “error still present,” “error has cleared,” etc.) within the communication. In an arrangement, the service management platform 110 may only tag communications that comprise a solution determined to be successful at resolving the service request.

At step 235, the service management platform 110 may perform a clustering analysis of the tagged keywords for determining one or more groups of the keywords for storing into the knowledge base 125. In an example, the clustering analysis may be used to add the keywords to one or more groups of keywords (e.g., already included in the knowledge base). Communications, associated with/comprising the keywords, may also be included in the one or more groups. The communications may comprise prospective solutions as discussed/attempted for resolving the service request (e.g., as described with respect to step 225).

In an arrangement, the service management platform 110 may only perform clustering analysis on communications that include keywords indicating success of prospective solutions within the communications. In this manner, the determined one or more groups may only include keywords (and associated communications) that were relevant for resolving the issue.

For example, a communication comprising the words/phrases “device identifier AA, error code Y, issue resolved” may be included in a first group. A communication comprising the words/phrases “application identifier BB, error code D, error has cleared” may be included in the second group. A communication comprising the words/phrases “application identifier CC, SME name1, error has cleared” may be included in the third group.

A clustering algorithm used for the clustering analysis may comprise one or more of hierarchical clustering, centroid-based clustering, density-based clustering, and/or distribution-based clustering. While the various examples herein refer to the use of a clustering algorithm for categorizing the plurality of keywords into one or more groups, any unsupervised machine learning algorithm may be used instead without departing from the scope of this invention.

At step 240, the service management platform 110 may receive a second service request as input by a user at a user device 210. The user device 210 may be, for example, the enterprise user computer device 115 or the computing device 140. The service request may be for reporting an error/malfunction (e.g., incident) involving a computing resource, requesting expert assistance for operating/using a computing resource, or simply a query regarding a computing resource. The computing resource may be a computing system, device, application, and/or the like. The computing resource may be, for example, the user device 210.

The second service request may comprise an indication of the computing resource (e.g., application name/version number, computing device name/model number). The service request may additionally comprise a description of the service request. The description may comprise symptoms being exhibited by the computing resource, operations being attempted on the computing resource, error codes being displayed for the computing resources, etc.

At step 245, the service management platform 110 may extract second keywords within a service request description of the second service request. For example, the NLP module 162 may use a keyword extraction algorithm for identifying one or more second keywords within a service request description of the second service request (e.g., as described above with respect to step 230).

At step 250, the service management platform 110 may determine prospective solutions for the second service request based on matching the second keywords with keywords associated with one or more groups in the knowledge base. For example, service management platform 110 may determine one or more of the communications, included in a group, comprising keywords that match one or more of the second keywords. The one or more communications may correspond to one or more prospective solutions for the second service request.

For example, if the second keywords include the words/phrases “device identifier AA, error code Y,” the one or more communications may comprise communications included in the first group. As another example, if the second keywords include the words/phrases “application identifier BB, error code D,” the one or more communications may comprise communications included in the second group. As another example, if the second keywords include the words/phrases “application identifier CC,” the one or more communications may comprise an indication of the “SME name1” included in the second group.

At step 255, the service management platform 110 may send indications of the one or more communications to the user device 210. The one or more communications may comprise one or more prospective solutions. The user associated with the user device may attempt the one or more prospective solutions corresponding to/indicated by the one or more communications. In another example, the service management platform 110 may automatically execute one or more steps corresponding to the one or more prospective solutions.

If there are multiple prospective solutions associated with the second service request, the service management platform 110 may send the multiple prospective solutions based on a ranking of the respective prospective solutions. The ranking may be based on a likelihood of success for resolving the service request. For example, the service management platform 110 may send a highest ranked prospective solution of the one or more prospective solutions.

At step 260, the service management platform 110 may receive, from the user device 210, an indication of whether a prospective solution, of the one or more prospective solutions, was successful in resolving the issue. If the prospective solution was successful in resolving the issue, the service management platform 110 may increase a ranking of the prospective solution for responding to future service requests. If the prospective solution was not successful in resolving the issue, the service management platform 110 may reduce a ranking of the prospective solution for responding to future service requests.

A ranking of the prospective solution may also be based on a source of the prospective solution. For example, a prospective solution from a vendor manual associated with the computing resource may be placed higher in rank than a solution based on a weblink to an online forum. The ranking may also be determined based on whether a prospective solution previously successful in resolving a service request. A ranking of the prospective solution may also be based on a number of matches between the second keywords and keywords associated with a group. Communications/prospective solutions in a group with a first number of keywords that match the second keywords may be ranked higher than communications/prospective solutions in a group with a second number of keywords that match the second keywords, if the second number is less than the first number.

In addition to the knowledge base 125, the service management platform 110 may leverage one or more other optional sources for determining the prospective solutions. The optional sources may include, but are not limited to, internet resources (e.g., web search results), vendor support documentation, vendor websites, online books/articles/tutorials, courses, wikis, other knowledge repositories. In one such embodiment, the service management platform 110 may scan the optional sources based on the second keywords to determine and send prospective solutions to the user device 210.

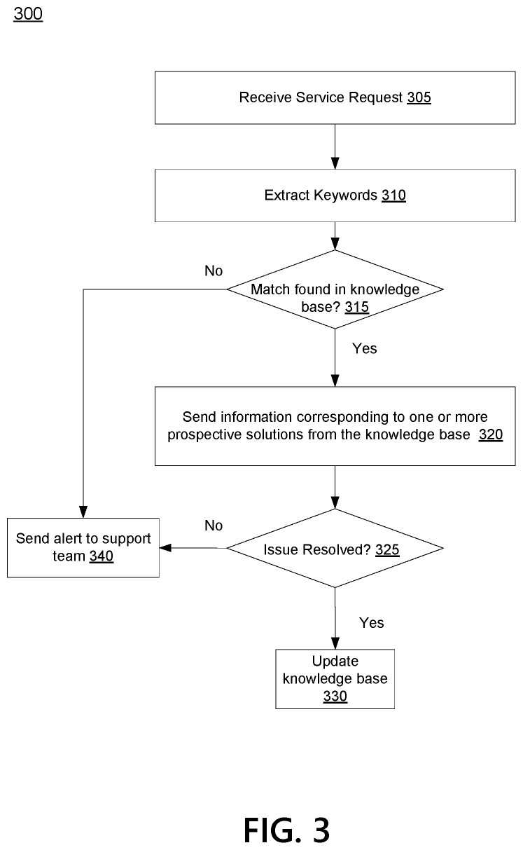

FIG. 3 shows an example method 300 for processing a service request. The example method 300 may be performed at the service management platform 110 as shown in the computing environment 100.

At 305, the service management platform 110 may receive a service request as input by a user at a user device. The user device may be, for example, the enterprise user computer device 115 or the computing device 140. The service request may be for reporting an error/malfunction (e.g., incident) involving a computing resource, requesting expert assistance for operating/using a computing resource, or simply a query regarding a computing resource.

At step 310, the service management platform 110 may extract keywords within a service request description of the second service request. At step 315, the service management platform 110 may attempt to find a match between the extracted keywords and keywords associated with one or more groups of solutions present in the knowledge base 125. If no match is found, the service management platform 110 may send an alert message to one or more computing devices associated with a support team (e.g., step 340).

At step 320, and if a match is found match between the extracted keywords and keywords associated with one or more groups of prospective solutions present in the knowledge base 125, the service management platform 110 may send information corresponding to one or more prospective solutions in the one or more groups. The one or more prospective solutions may correspond to highest ranked solutions in the one or more groups.

The ranking of the one or more solutions may be based on a points-based system. A number of points may be assigned based on a source of the solution, based on whether the solution has previously succeeded in resolving the error/malfunction/issue, and/or based on a number of matched keywords associated with a group comprising the one or more solutions. A solution with a higher number of points may be ranked higher. A higher number of points may be assigned to solutions from more trusted sources (e.g., SMEs, vendor documentation, etc.). A number of points may be assigned to a solution based on a quantity of keywords, of a group including the solution, that match the extracted keywords. Points may be added to each solution based on a quantity of times it has previously successfully resolved a service request.

The one or more prospective solutions may be sent to the user device and implemented by the user associated with the user device. Additionally, or alternatively, the one or more prospective solutions may be sent to the computing resource/user device for automatic execution in an attempt to resolve the error/malfunction.

At step 325, the service management platform 110 may determine whether an issue corresponding to the service request has been resolved. For example, the service management platform 110 may receive an indication, from the user device or the computing resource, of whether or not the issue has been resolved and the prospective solution which resolved the issue. If the issue has been resolved, the service management platform 115 may update the knowledge base to add points to the prospective solution that resolved the issue (e.g., step 330). If the issue has not been resolved, the service management platform 110 may send an alert message to one or more computing devices associated with a support team (e.g., step 340).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising
a processor; and
memory storing computer-readable instructions that, when executed by the processor, cause the computing platform to:
receive, from a first user computing device, a first service request, wherein the first service request comprises a first service description;
assign, to the first service request, a ticket number;
receive, from a second user computing device, an indication for closing of the first service request;
identify, based on the ticket number, one or more communications associated with the first service request;
based on natural language processing (NLP) of the one or more communications and the first service description, extract one or more first keywords associated with the one or more communications and the first service description;
tag, with the one or more first keywords, a subset of the one or more communications and the first service description;
perform cluster analysis, based on the first one or more keywords, to add the subset of the one or more communications and the first service description to one or more groups of solutions in a knowledge base;
receive, from a third user computing device, a second service request wherein the second service request comprises a second service description;
based on NLP of the second service description, extract one or more second keywords associated with the second service description; and
based on determining a match between the one or more first keywords and the one or more second keywords, send, to the third user computing device, at least one solution of the one or more groups of solutions.

2. The computing platform of claim 1, wherein the computer-readable instructions, when executed by the processor, cause the computing platform to tag the subset of the one or more communications and the first service description based on identifying, within the one or more communications, one or more trigger words.

3. The computing platform of claim 1, wherein the computer-readable instructions, when executed by the processor, cause the computing platform to tag the subset of the one or more communications and the first service description based on receiving an indication that the first service request has been resolved.

4. The computing platform of claim 1, wherein the subset of the one or more communications comprise one or more prospective solutions for the first service request.

5. The computing platform of claim 1, wherein the one or more communications comprise one or more:
emails,
text messages,
instant messages,
voice transcripts,
screen captures, or
documents.

6. The computing platform of claim 1, wherein the one or more first keywords comprise an identifier of a computing resource associated with the first service request.

7. The computing platform of claim 6, wherein the computing resource is one of a computing device, software application, or a computing system.

8. The computing platform of claim 1, wherein the computer-readable instructions, when executed by the processor, cause the computing platform to send the at least one solution of the one or more groups of solutions based on:
ranking prospective solutions in the one or more groups of solutions based on a historical record of success of the prospective solutions; wherein the at least one solution is a highest ranked solution in the one or more groups of solutions.

9. The computing platform of claim 1, wherein the subset of the one or more communications comprises keywords indicating success of prospective solutions in the subset for resolving the service request.

10. The computing platform of claim 1, wherein the clustering analysis comprises one or more of hierarchical clustering, centroid based clustering, density based clustering, or distribution based clustering.

11. A method comprising:
receiving, from a first user computing device, a first service request, wherein the first service request comprises a first service description;
assigning, to the first service request, a ticket number;
receiving, from a second user computing device, an indication for closing of the first service request;
identifying, based on the ticket number, one or more communications associated with the first service request;
based on natural language processing (NLP) of the one or more communications and the first service description, extracting one or more first keywords associated with the one or more communications and the first service description;
tagging, with the one or more first keywords, a subset of the one or more communications and the first service description;
performing cluster analysis, based on the first one or more keywords, to add the subset of the one or more communications and the first service description to one or more groups of solutions in a knowledge base;
receiving, from a third user computing device, a second service request wherein the second service request comprises a second service description;
based on NLP of the second service description, extracting one or more second keywords associated with the second service description; and
based on determining a match between the one or more first keywords and the one or more second keywords, sending, to the third user computing device, at least one solution of the one or more groups of solutions.

12. The method of claim 11, wherein the tagging the subset of the one or more communications and the first service description is based on identifying, within the one or more communications, one or more trigger words.

13. The method of claim 11, wherein the tagging the subset of the one or more communications and the first service description is based on receiving an indication that the first service request has been resolved.

14. The method of claim 11, wherein the subset of the one or more communications comprise one or more prospective solutions for the first service request.

15. The method of claim 11, wherein the one or more communications comprise one or more:
emails,
text messages,
instant messages,
voice transcripts,
screen captures, or
documents.

16. The method of claim 11, wherein the one or more first keywords comprise an identifier of a computing resource associated with the first service request.

17. The method of claim 16, wherein the computing resource is one of a computing device, software application, or a computing system.

18. The method of claim 11, wherein the sending the at least one solution of the one or more groups of solutions is based on:
ranking prospective solutions in the one or more groups of solutions based on a historical record of success of the prospective solutions; wherein the at least one solution is a highest ranked solution in the one or more groups of solutions.

19. The method of claim 11, wherein the subset of the one or more communications comprises keywords indicating success of prospective solutions in the subset for resolving the service request.

20. One or more non-transitory computer-readable media storing instructions that, when executed by a computer processor, cause a computing platform to:
receive, from a first user computing device, a first service request, wherein the first service request comprises a first service description;
assign, to the first service request, a ticket number;
receive, from a second user computing device, an indication for closing of the first service request;
identify, based on the ticket number, one or more communications associated with the first service request;
based on natural language processing (NLP) of the one or more communications and the first service description, extract one or more first keywords associated with the one or more communications and the first service description;
tag, with the one or more first keywords, a subset of the one or more communications and the first service description;
perform cluster analysis, based on the first one or more keywords, to add the subset of the one or more communications and the first service description to one or more groups of solutions in a knowledge base;
receive, from a third user computing device, a second service request wherein the second service request comprises a second service description;
based on NLP of the second service description, extract one or more second keywords associated with the second service description; and
based on determining a match between the one or more first keywords and the one or more second keywords, send, to the third user computing device, at least one solution of the one or more groups of solutions.
